(19) United States
(12) Patent Application Publication
(10) Pub. No.: US 2012/0127070 A1
(43) Pub. Date: May 24, 2012

(54) CONTROL SIGNAL INPUT DEVICE AND METHOD USING POSTURE RECOGNITION

(75) Inventors: Dong Wan RYOO, Daejeon (KR); Jun Seok PARK, Daejeon (KR)

(73) Assignee: Electronics and Telecommunications Research Institute, Daejeon (KR)

(21) Appl. No.: 13/224,498

(22) Filed: Sep. 2, 2011

(30) Foreign Application Priority Data
Nov. 22, 2010 (KR) 10-2010-0116125

(51) Int. Cl. G09G 5/00

(52) U.S. Cl. 345/156

(57) ABSTRACT

Provided are a control signal input device and method using posture recognition. More particularly, the present invention relates to a control signal input device including: a database unit storing predetermined system control commands corresponding to postures of combinations of one or more of an arm, a wrist, and fingers of a user; a sensing unit sensing a posture of a combination of the arm, wrist, and fingers of the user; and a control signal generating unit extracting a system control command corresponding to the sensed result of the sensing unit from the database unit and generating a control signal for controlling the system, and a control signal input method using the same.

### CROSS-REFERENCE TO RELATED APPLICATIONS

This application claims the priority of Korean Patent Application No. 10-2010-0116125 filed on Nov. 22, 2010 in the Korean Intellectual Property Office, the disclosure of which is incorporated herein by reference in its entirety.

### BACKGROUND OF THE INVENTION

1. Field of the Invention

The present invention relates to a control signal input device and method using posture recognition. More particularly, the present invention relates to a control signal input device and method for driving a system such as a computer, which is capable of transmitting an input of a user without being restricted by various restrictions in the case of manipulating an electronic system such as a computer in a specific environment or a large-sized display.

2. Description of the Related Art

In general, for interaction between a human and computers, interface devices transmitting computer control commands by the human to the computers are necessary. In the related art, devices such as keyboards and mice separately provided are used as the interface devices; however, in order to manipulate those devices, it is required to use the keyboards and mice at specific positions where the keyboards and mice are provided, which is inconvenient.

From this point, currently, researches on a glove-type or wristband-type means, which is wearable on hands of humans and transmits control signals according to motions of the hand of the humans to computers to manipulate the computers, are being conducted. However, the glove-type input devices should be worn on hands of users, and the wristband-type input devices can just generate limited input signals according to motions of fingers and movements of the wrists; however, cannot generate various kinds of input signals.

### SUMMARY OF THE INVENTION

The present invention has been made in an effort to provide a device and method for generating various system control signals by complexly recognizing postures of arms, wrists, and fingers of a user.

Further, the present invention has been made in an effort to provide a device and method capable of a free system control in a specific environment such as an operating room by enabling the user to freely use hands.

In addition, the present invention has been made in an effort to provide an arm-band-type control signal input device wearable on a wrist of a user. The control signal input device generates a signal for system control by recognizing finger and wrist postures of the user together with an arm posture of the user, that is, a roll value as a reference, and thus can generate different control signals depending on the arm posture in spite of the same wrist and finger postures. Therefore, it is possible to generate more various control signals.

However, the technical objects of the present invention are not limited to the above-mentioned description, and another objects not described will be understood by those skilled in the art from the following description.

An exemplary embodiment of the present invention provides a control signal input device for controlling a system including: a database unit storing predetermined system control commands corresponding to postures of combinations of one or more of an arm, a wrist, and fingers of a user; a sensing unit sensing a posture of a combination of one or more of the arm, wrist, and fingers of the user; and a control signal generating unit extracting a system control command corresponding to the sensed result of the sensing unit from the database unit and generating a control signal for controlling the system.

Another exemplary embodiment of the present invention provides a control signal input method for controlling a system including: (a) building a database with system control commands corresponding to postures of an arm, a wrist, and fingers of a user stored therein; (b) sensing postures of the arm, wrist, and fingers of the user; and (c) extracting a system control command corresponding to the sensed result, and generating a control signal for controlling the system.

Here, the control signal input device may be formed in an arm-band type to be wearable on the wrist of the user, and uses various kinds of sensors in order to sense motions and positions (postures) of the arm, wrist, and fingers of the user. These sensors may generally include an inertial sensor for sensing the motion and position of the arm, a proximity sensor array for sensing the posture of the wrist, and piezoelectric sensors for sensing the motion and position of the fingers. The various sensors used in the exemplary embodiments of the present invention and the functions thereof will be described below.

According to the exemplary embodiments of the present invention, since the posture recognition is performed by reflecting the posture of the arm to the position and motion of the wrist and fingers, it is possible to generate different system control signals with respect to the same wrist and finger postures according to the postures of the arms.

Further, since a device such as a glove-type input device restricting the hand of the user is not provided, it is possible to reduce the restriction of the motion of the hand.

Furthermore, in the case where a doctor wants to scan information on a patient by manipulating a computer during a surgery in a specific environment such as an operating room, it is possible to generate a computer control signal without taking off the operating gloves.

### BRIEF DESCRIPTION OF THE DRAWINGS

FIG. 1 is a block diagram schematically illustrating a control signal input device according to an exemplary embodiment of the present invention;

FIGS. 2 and 3 are block diagrams for explaining the block diagram of FIG. 1 in more detail;

FIG. 4 is a view for explaining an arm-band-type control signal input device according to an exemplary embodiment of the present invention;

FIG. 5 is a view illustrating a procedure of generating different control signals according to the posture recognition in a control signal input device according to an exemplary embodiment of the present invention;

FIG. 6 is a view for explaining kinds of control signals generated in a control signal input device according to an exemplary embodiment of the present invention by examples; and

FIGS. 7 and 8 are views illustrating a control signal input method according to an exemplary embodiment of the present invention.

### DETAILED DESCRIPTION OF THE EMBODIMENTS

Hereinafter, exemplary embodiments of the present invention will be described in detail with reference to the accompanying drawings. When an element or layer is referred to as being “connected to” and/or “coupled to” another element or layer, it can be directly connected or coupled to the other element or layer or intervening elements or layers may be present. It should be noted that identical or corresponding components are designated by the same reference numerals throughout the drawings. In this case, the configurations and effects illustrated in and described by the drawings will be described in at least one exemplary embodiment and the technical scope, core configurations, and effects of the present invention is not limited thereto.

Several terms to be used in the specification will be described before the detailed description on the exemplary embodiments of the present invention.

In the exemplary embodiments of the present invention, a system means a control subject which a user wants to control and generally corresponds to a computer. Further, control according to the positions and motions of an arm, a wrist, and fingers of the user generally means control of a mouse pointer or curser on a computer screen (monitor), and includes a mouse click, rotation of an object on the screen, scrolling, dragging, operation start, operation stop, window reduction, window enlargement, window maximization, window close, screen enlargement, screen reduction, etc.

Further, it should be noted that the terms ‘position’ and ‘motion’ regarding a position and motion of an arm, wrist, or fingers of the user can be substituted with a term ‘posture’, and in particular, it also should be noted that a posture of the arm is referred to as a rolling posture of the arm.

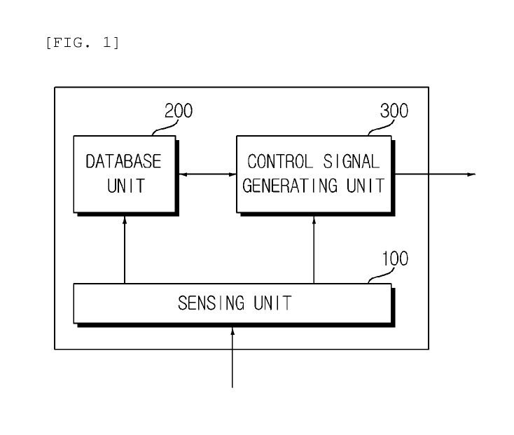

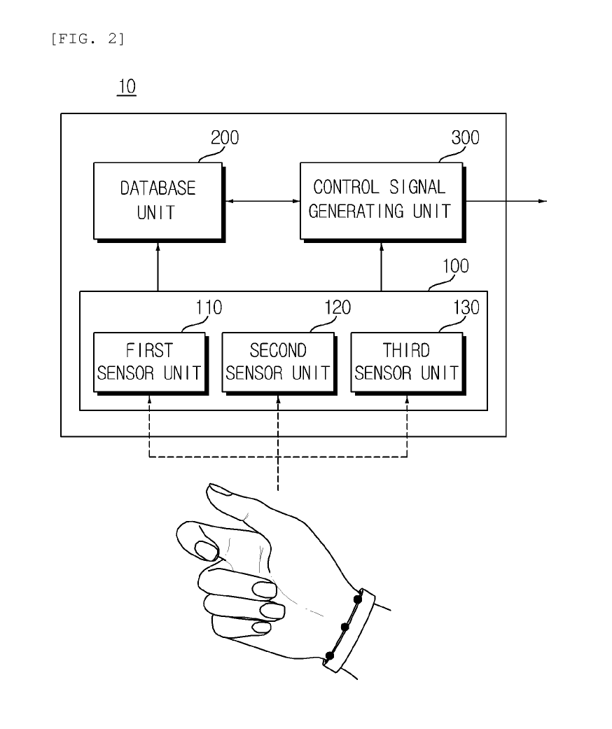

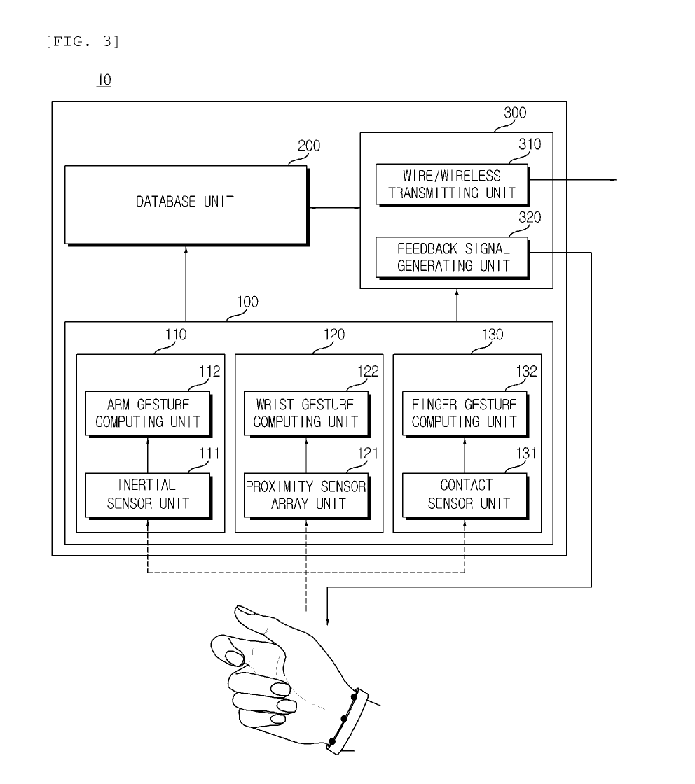

FIG. 1 is a block diagram schematically illustrating a control signal input device according to an exemplary embodiment of the present invention, and FIGS. 2 and 3 are block diagrams for explaining the block diagram of FIG. 1 in more detail.

As shown in FIG. 1, a control signal input device 10 according to an exemplary embodiment includes a sensing unit 100, a database unit 200, and a control signal generating unit 300.

The database unit 200 stores predetermined system control commands corresponding to postures of an arm, a wrist, and fingers of a user. That is, the user initially sets control commands applied to a system according to the positions and motions of the user's own arm, wrist, and fingers.

The sensing unit 100 senses the postures of the arm, wrist, and fingers of the user. The sensing unit 100 includes 3 sensor units as shown in FIG. 2. A first sensor unit 110 senses the roll posture of the arm of the user, a second sensor unit 120 senses the posture of the wrist of the user, and a third sensor unit 130 senses the posture of the fingers of a user. The above-mentioned sensor units 110, 120 and 130 will be described in more detail.

As shown in FIG. 3, the first sensor unit 110 includes an inertial sensor unit 111 and an arm gesture computing unit 112, the second sensor unit 120 includes a proximity sensor array unit 121 and a wrist gesture computing unit 122, and the third sensor unit 130 includes a contact sensor unit 131 and a finger gesture computing unit 132.

The inertial sensor unit 111 includes at least one gyro sensor or acceleration sensor and senses the vertical or horizontal motion (that is, rolling) of the arm of the user. Here, the inertial sensor unit 111 recognizes the rolling posture of the arm by using an acceleration value or tilt value of the provided acceleration sensor or an angular velocity value of the gyro sensor. In particular, in the acceleration sensor, since the tilt value is provided in addition to the acceleration value, it is possible to simply recognize the posture of a hand by the tilt value, and to generate totally different control signals according to the posture of the arm by the posture recognition in the case of the same gesture as an arbitrary gesture of the wrist and fingers to be described below. Further, the sensing of the inertial sensor unit 111 may be used as an operation start point signal of the control signal input device 10.

The arm gesture computing unit 112 computes a signal for system (computer) control by using the posture of the arm of the user sensed by the inertial sensor unit 111. That is, the arm gesture computing unit 112 receives a motion of the arm in a user space like a vertical or horizontal movement of a computer mouse pointer according to a motion of the arm, and computes x-y coordinates.

The proximity sensor array unit 121 is formed by arranging at least one proximity sensor. The proximity sensor array unit 121 senses a motion of the wrist based on a motion, such as a vertical or horizontal motion, a rotation, etc., of the hand. Here, in order to sense a motion of the wrist, the proximity sensor array unit 121 is formed in an array of one or more proximity sensors. Examples of the proximity sensor may include a capacitive proximity sensor, an infrared proximity sensor, an ultrasonic proximity sensor, an optical proximity sensor, etc. The proximity sensor array unit 121 receives an input corresponding to a click, rotation, scrolling, etc. of a computer mouse, from the proximity sensor array.

The wrist gesture computing unit 122 computes a signal for system control by using a signal input from the proximity sensor array unit 121. That is, the wrist gesture computing unit 122 computes a left or right click or a degree of scrolling of the computer mouse according to the motion of the wrist.

The contact sensor unit 131 is formed with a piezoelectric sensor or a vibration sensor to sense the motion of wrist muscles according to the posture of the fingers of the user. The contact sensor unit 131 is brought into contact with the wrist portion in order to sense the motion of the fingers of the user, and senses a motion signal of the wrist muscles according to the motion of the fingers. An input such as a left or right click or double-click of the computer mouse is received from the contact sensor unit 131.

The finger gesture computing unit 132 computes a signal for system control from the signal input to the contact sensor unit 131. That is, the finger gesture computing unit 132 computes the number of times a computer mouse is clicked, etc., according to the motion of the fingers.

The control signal generating unit 300 shown in FIGS. 1 to 3 extracts a system control command corresponding to the sensed result of the sensing unit 100 from the database unit 200 and generates a control signal for controlling the system. Further, the control signal generating unit 300 includes a wire/wireless transmitting unit 310 and a feedback signal generating unit 320.

The wire/wireless transmitting unit 310 is provided to transmit the control signal generated in the control signal generating unit 300 to the system and may be connected to the system in a wire or wireless manner.

The feedback signal generating unit 320 generates a touch sensation signal corresponding to the control signal generated in the control signal generating unit 300 and feeds the touch sensation signal back to the user. That is, the feedback signal generating unit 320 determines the left or right click, scrolling of the computer mouse, etc., and feeds a haptic (vibration) signal corresponding thereto back to the user.

An example of the above-mentioned control signal input device which is wearable on the wrist of the user will be described below.

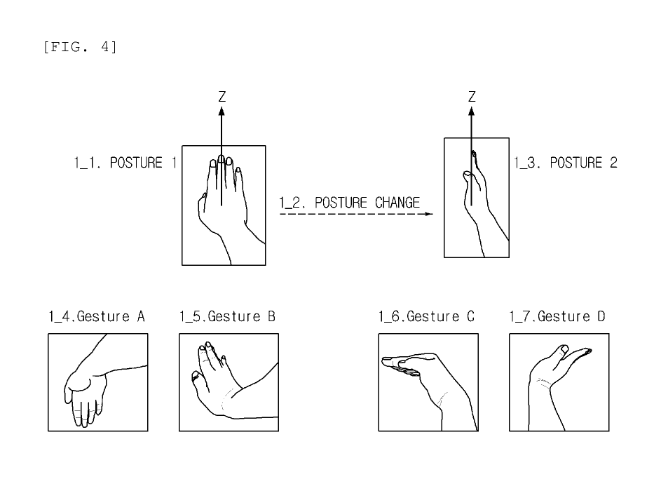

FIG. 4 is a view for explaining an arm-band-type control signal input device according to an exemplary embodiment of the present invention.

As shown in FIG. 4, a control signal input device 10 may be manufactured in an arm band type. In this case, the inertial sensor unit 111 includes a gyro sensor or an acceleration sensor and recognizes the rolling posture of the arm. The proximity sensor array unit 121 includes a plurality of proximity sensors and senses the motion of the wrist of the user. In order to recognize the finger posture, the contact sensor unit 131 is formed at a position where it can be brought into contact with a wrist muscle portion of the user.

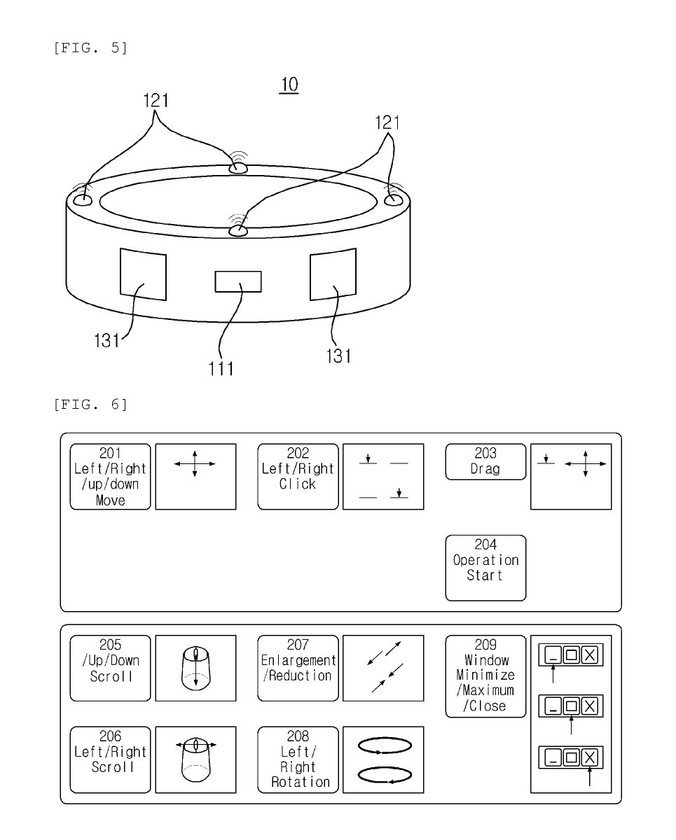

A method of inputting various control signals according to the posture recognition according to an exemplary embodiment of the present invention will be described below with reference to FIG. 5. FIG. 5 is a view illustrating a procedure of generating different control signals according to the posture recognition in a control signal input device according to an exemplary embodiment of the present invention.

Reference symbol 1_1 denotes a state in which a palm faces the ground, which is referred to as posture 1.

Reference symbol 1_2 denotes a posture change of the hand such as a rotation from the state in which the palm faces the ground to a state in which the palm stands lengthways, which is simply referred to as a posture change. Posture change recognition can sense a posture of the hand by a signal of one or more of a tilt value and an acceleration value of the acceleration sensor, and an angular velocity value of the angular velocity sensor attached to the wrist.

Reference symbol 1_3 denotes a state in which the palm faces the west, that is, the hand stands vertically, which is simply referred to as position 2.

Reference symbol 1_4 denotes a gesture of bending the wrist downward from the state in which the palm faces the ground (posture 1), which is simply referred to as gesture A. Gesture A may correspond to a left click, a right click, left scrolling, right scrolling, up scrolling, or down scrolling.

Reference symbol 1_5 denotes a gesture of bending the wrist upward from the state in which the palm faces the ground (posture 1), which is simply referred to as gesture B. Gesture B may correspond to a left click, a right click, left scrolling, right scrolling, up scrolling, or down scrolling.

Reference symbol 1_6 denotes a gesture of bending the wrist to the west from the state in which the palm faces the west (posture 2), that is, the hand stands vertically, which is simply referred to as gesture C. Gesture C is recognized in the sensor worn on the wrist as the same gesture or posture as gesture A and thus is mapped to a different gesture. That is, two input signals can be generated from the same gesture.

Reference symbol 1_7 denotes a gesture of bending the wrist to the east from the state in which the palm faces the west (posture 2), that is, the hand stands vertically, which is simply referred to as gesture D. Gesture D is recognized in the sensor worn on the wrist as the same gesture or posture as gesture B and thus is mapped to a different gesture. That is, two input signals can be generated from the same gesture.

As described above, since the posture (tilt) of the arm is first recognized, an arm or wrist or finger motion gesture can be recognized and input as different gestures, and thus it is possible to increase the number of gesture inputs twice as much as the existing inputs.

The kinds of control signals generated according to an exemplary embodiment of the present invention will be described below.

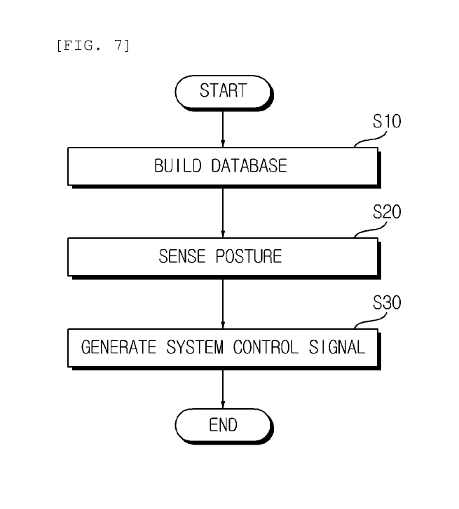

FIG. 6 is a view for explaining the kinds of control signals generated in a control signal input device according to an exemplary embodiment of the present invention by examples.

Reference numeral 201 denotes a vertical or horizontal movement input signal. The vertical or horizontal gesture of the arm corresponding to coordinate movement of the computer mouse is defined by using the sensor of the above-mentioned inertial sensor unit, and the vertical or horizontal movement or coordinates of the computer mouse pointer are extracted on the basis of the made gesture. That is, for example, if the inertial sensor (gyro sensor or acceleration sensor) senses the vertical movement of the arm, the mouse cursor moves vertically, and if the inertial sensor senses the horizontal movement of the arm, the mouse cursor moves horizontally.

Reference numeral 202 denotes a left or right click input signal. A left or right click gesture of the wrist corresponding to the left or right click of the computer mouse is defined by using the sensors of the above-mentioned proximity sensor array unit, and the left or right click of the computer mouse is extracted as an input signal on the basis of the corresponding gesture. For example, if the wrist is bent downward in the space, this gesture may be recognized as a left click by proximity signals of the sensors mounted on the wrist, and a signal corresponding to the left button click of the computer mouse may be generated. Similarly, if the wrist is bent upward, a signal corresponding to the right button click of the mouse may be generated.

Alternatively, a left or right click gesture of the fingers corresponding to the left or right click of the computer mouse may be defined by using the piezoelectric (vibration) sensor of the above-mentioned contract sensor unit, and the left or right click may be extracted as an input signal of the system by the corresponding gesture. For example, if the index finger is bent, this gesture may be recognized as the left click by the piezoelectric (vibration) sensor mounted on the wrist and a signal corresponding to the left button click of the mouse may be generated. Similarly, if the middle finger is bent, a signal corresponding to the right button click of the mouse may be generated.

Reference numeral 203 denotes a drag input signal. A drag gesture of the arm or wrist of the user corresponding to the drag of the computer mouse may be defined and the drag input signal may be extracted by the corresponding gesture.

Reference numeral 204 denotes a start (start point) signal. A start point gesture of the arm or wrist for starting an operation of a space input device may be defined and a state point signal may be extracted by the corresponding gesture.

Reference numeral 205 denotes an up or down scroll signal. An up or down scroll gesture corresponding to the up or down scroll of the computer mouse may be defined and an up or down scroll signal may be extracted by the corresponding gesture.

Reference numeral 206 denotes a left or right scroll signal. A left or right scroll gesture corresponding to the left or right scroll may be defined and a left or right scroll signal may be extracted by the corresponding gesture. For example, this gesture corresponds to gesture C or D of FIG. 5.

Reference numeral 207 denotes a screen enlargement or reduction signal. A gesture corresponding to the enlargement or reduction of the computer screen may be defined and the screen enlargement or reduction signal may be extracted by the corresponding gesture.

Reference numeral 208 denotes a left or right rotation signal for an object. A gesture corresponding to the left or right rotation of the object on the computer screen may be defined and a control signal for left or right rotation of the object on the computer screen may be extracted by the corresponding gesture.

Reference numeral 209 denotes a window minimization, maximization, or close signal. A gesture corresponding to the click of the minimization, maximization, or close icon of the window on the computer screen may be defined and a control signal for the minimization, maximization, or close of the window may be extracted by the corresponding gesture.

Next, a control signal input method according to an exemplary embodiment of the present invention will be described below.

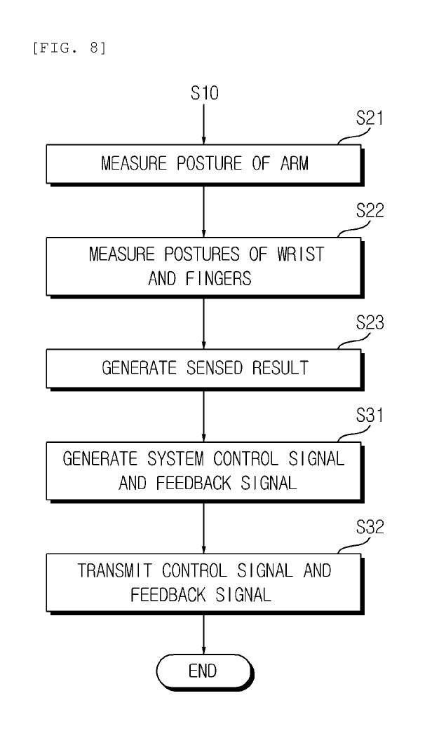

FIGS. 7 and 8 are views illustrating a control signal input method according to an exemplary embodiment of the present invention.

As shown in FIG. 7, a control signal input method includes a step of building a database (step S10), a step of sensing a posture (step S20), and a step of generating a system control signal (step S30).

Step S10 is a step of defining system control commands corresponding to the postures of the arm, wrist, and fingers of the user and storing the system control commands in the database. In step S10, the user defines the control commands necessary for controlling the system (computer) by the above-mentioned control signal input device and sets the control commands in the database.

Step S20 is a step of sensing the positions and motions of the arm, wrist, and fingers of the user, that is, the posture (gesture) of the user, and step S30 is a step of extracting a system control command corresponding to the sensed result in step S20 from the database and generating a control signal for controlling the system (computer) from the system control command. Here, the steps S20 and S30 will be described in more detail with reference to FIG. 8. As shown in FIG. 8, steps S20 and S30 include a step of measuring the gesture of the arm of the user (step S21), a step of measuring the gestures of the wrist and fingers of the user (step S22), a step of generating one sensed result by combining the measurement results of steps S21 and S22 (step S23), a step of generating a system control signal corresponding to the sensed result and generating a feedback signal for feeding a touch sensation signal (haptic signal) corresponding to the control signal back to the user (step S31), and a step of transmitting the control signal and the feedback signal of step S31 (step S32). Since details of the control signal input method can be understood by referring to the detailed description of the control signal input device, for simple description of the specification, a repeated description is omitted.

Although the exemplary embodiments of the present invention have been described above with reference to the accompanying drawings, the present invention is not limited to the exemplary embodiments. It will be apparent to those skilled in the art that modifications and variations can be made in the present invention without deviating from the spirit or scope of the invention. Therefore, the scope of the present invention is defined by only the claims and all of the equal or equivalent modifications belong to the scope of the present invention.

What is claimed is:

1. A control signal input device for controlling a system, comprising:
a database unit storing predetermined system control commands corresponding to postures of combinations of one or more of an arm, a wrist, and fingers of a user;
a sensing unit sensing a posture of a combination of the arm, wrist, and fingers of the user; and
a control signal generating unit extracting a system control command corresponding to the sensed result of the sensing unit from the database unit and generating a control signal for controlling the system.

2. The control signal input device according to claim 1, wherein:
the sensing unit includes
a first sensor unit sensing a rolling posture of the arm of the user,
a second sensor unit sensing a posture of the wrist of the user, and
a third sensor unit sensing a posture of the fingers of the user.

3. The control signal input device according to claim 2, wherein:
the first sensor unit includes
an inertial sensor unit having at least one gyro sensor or acceleration sensor, and
an arm gesture computing unit computing a signal for controlling the system from the rolling posture of the arm of the user sensed by the inertial sensor unit.

4. The control signal input device according to claim 3, wherein:
the inertial sensor unit senses the rolling posture of the arm of the user by using one or more of an angular velocity value of the gyro sensor, a tilt value of the acceleration sensor, and an acceleration value of the acceleration sensor.

5. The control signal input device according to claim 4, wherein:
the sensed result of the sensing unit is generated by combining a rolling value of the arm of the user sensed by the inertial sensor unit, a posture value of the wrist of the user sensed by the second sensor unit, and a posture value of the fingers of the user sensed by the third sensor unit.

6. The control signal input device according to claim 2, wherein:
the second sensor unit includes
a proximity sensor array unit formed by arranging at least one proximity sensor, and
a wrist gesture computing unit computing a signal for controlling the system from a signal according to the posture of the wrist of the user sensed by the proximity sensor array unit.

7. The control signal input device according to claim 2, wherein:
the third sensor unit includes
a contact sensor unit formed of a piezoelectric sensor or a vibration sensor for sensing a motion of wrist muscles according to a posture of the fingers of the user, and
a finger gesture computing unit computing a signal for controlling the system from a signal according to the posture of the fingers of the user sensed by the contact sensor unit.

8. The control signal input device according to claim 1, wherein:
the control signal generating unit includes
a feedback signal generating unit generating the control signal, generating a touch sensation signal corresponding to the control signal at the same time, and feeding the touch sensation signal back to the user.

9. The control signal input device according to claim 1, wherein:
the control signal generating unit includes
a wire/wireless transmitting unit transmitting the control signal in a wire/wireless manner.

10. The control signal input device according to claim 1, wherein:
the control signal input device is formed in an arm-band type to be wearable on the wrist of the user.

11. A control signal input method for controlling a system comprising:
(a) building a database with system control commands corresponding to postures of combinations of one or more of an arm, a wrist, and fingers of a user stored therein;
(b) sensing postures of the arm, wrist, and fingers of the user; and
(c) extracting a system control command corresponding to the sensed result, and generating a control signal for controlling the system.

12. The control signal input method according to claim 11, wherein:
the (b) includes:
(b1) measuring a rolling posture of the arm of the user;
(b2) measuring motions of the wrist and fingers of the user; and
(b3) generating one sensed result by combining the measurement results of the (b1) and the (b2).

13. The control signal input method according to claim 12, wherein:
in the (b1),
a tilt value or an acceleration value of an acceleration sensor according to rolling of the arm is measured by using the acceleration sensor, or an angular velocity value according to the rolling of the arm is measured by using a gyro sensor.

14. The control signal input method according to claim 11, wherein:
the (c) further includes generating a touch sensation signal corresponding to the control signal at the same time as the control signal is generated.

15. The control signal input method according to claim 11, further comprising:
(d) transmitting the control signal to the system in a wire or wireless manner and transmitting the touch sensation signal to the user after the (c).
